(19) United States
(12) Patent Application Publication
(10) Pub. No.: US 2026/0362374 A1
(43) Pub. Date: Nov. 12, 2026

(54) RAPID MESH NODE PLACEMENT CUES

(71) Applicant: Charter Communications Operating, LLC, St. Louis, MO (US)

(72) Inventors: Dileep Kumar Soma, Parker, CO (US); Tohme Tohme, Aurora, CO (US)

(21) Appl. No.: 19/200,107

(22) Filed: May 6, 2025

(51) Int. Cl. H04W 64/00; H04W 24/08

(52) U.S. Cl. CPC H04W 64/00; H04W 24/08

(57) ABSTRACT

A first wireless node initiates a location mode. A first radio frequency (RF) signal set comprising one or more RF signals is received from a second wireless node. A signal strength based on the first RF signal set is determined. Based on the signal strength a first location category of a plurality of location categories is identified. A first perceptible event of a plurality of perceptible events is output, wherein the first perceptible event is indicative of the first location category.

### BACKGROUND

Wireless mesh nodes are often used to implement wireless services throughout a premises.

### SUMMARY

The examples disclosed herein can provide rapid placement cues even before a first wireless node has connected to a second wireless node, obtained an IP address, and communicated with an external server to run a speed test.

In one implementation a method is provided. The method includes initiating, by a first wireless node, a location mode. The method further includes receiving, by the first wireless node, a first radio frequency (RF) signal set comprising one or more RF signals from a second wireless node. The method further includes determining, by the first wireless node, a signal strength based on the first RF signal set. The method further includes identifying, by the first wireless node based on the signal strength, a first location category of a plurality of location categories. The method further includes outputting a first perceptible event of a plurality of perceptible events, wherein the first perceptible event is indicative of the first location category.

In another implementation a first wireless node is provided. The first wireless node includes a memory, and a processor device communicatively coupled to the memory. The processor device is operable to initiate a location mode. The processor device is further operable to receive a first radio frequency (RF) signal set comprising one or more RF signals from a second wireless node. The processor device is further operable to determine a signal strength based on the first RF signal set. The processor device is further operable to identify, based on the signal strength, a first location category of a plurality of location categories. The processor device is further operable to output a first perceptible event of a plurality of perceptible events, wherein the first perceptible event is indicative of the first location category.

In another implementation a non-transitory computer-readable storage medium is provided. The non-transitory computer-readable storage medium includes executable instructions operable to cause a processor device of a first wireless node to initiate a location mode. The instructions are further operable to cause the processor device to receive a first radio frequency (RF) signal set comprising one or more RF signals from a second wireless node. The instructions are further operable to cause the processor device to determine a signal strength based on the first RF signal set. The instructions are further operable to cause the processor device to identify, based on the signal strength, a first location category of a plurality of location categories. The instructions are further operable to cause the processor device to output a first perceptible event of a plurality of perceptible events, wherein the first perceptible event is indicative of the first location category.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which rapid mesh node placement cues can be practiced according to some implementations;

FIG. 2 is a flowchart of a method for implementing rapid mesh node placement cues according to some implementations;

FIGS. 3A-3C illustrate a sequence diagram illustrating an example implementation of rapid mesh node placement cues; and

FIG. 4 is a block diagram of a wireless node suitable for implementing rapid mesh node placement cues according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Wireless mesh nodes are often used to implement wireless services throughout a premises. Placement of wireless mesh nodes can involve guess work, following by running tests through the mesh node, such as speed tests that test the bandwidth of the wireless mesh node while downloading a file from a remote server, such as a server on the Internet or in a service providers network. If the bandwidth is insufficient, the wireless mesh node may be moved to another location and the process repeated again and again until a location that provides sufficient bandwidth is determined. This process can be time-consuming and frustrating. When a technician of a service provider performs this task it can also be costly.

The examples disclosed herein implement rapid mesh node placement cues. The examples disclosed herein are particularly suited for wireless extender nodes that do not have a wired backhaul connection and thus must communicate with another wireless node via wireless technologies to implement a backhaul connection. In one implementation, a first wireless node, such as by way of non-limiting example, a wireless extender node that extends a wireless network, such as a Wi-Fi network, initiates a location mode. The first wireless node receives radio frequency (RF) signals from a second wireless node, such as, by way of non-limiting example, a wireless gateway, or another wireless extender node. The first wireless node determines a signal strength based on the RF signals and identifies, based on the signal strength, a first location category of a plurality of location categories. The location categories may include, for example, a too close location category, a too far location category, or a good location category. The first wireless node outputs a first perceptible event of a plurality of perceptible events. The first perceptible event is indicative of the first location category. For example, the first location category may be the too close location category and the first perceptible event may be a purple blinking light that is indicative of the too close location category. The technician can perceive the perceptible event and act accordingly. For example, if the perceptible event corresponds to the too close location category, the technician may unplug the first wireless node, move the first wireless node to another electrical outlet that is farther from the second wireless node, and repeat the process.

The examples disclosed herein can provide rapid placement cues even before the first wireless node has connected to the second wireless node, obtained an IP address, and communicated with an external server to run a speed test. The examples disclosed herein allow a homeowner or technician to rapidly test various locations in a premises to identify a good location for a wireless node and thus reduces frustration, time and cost when adding wireless extender nodes to a wireless mesh network.

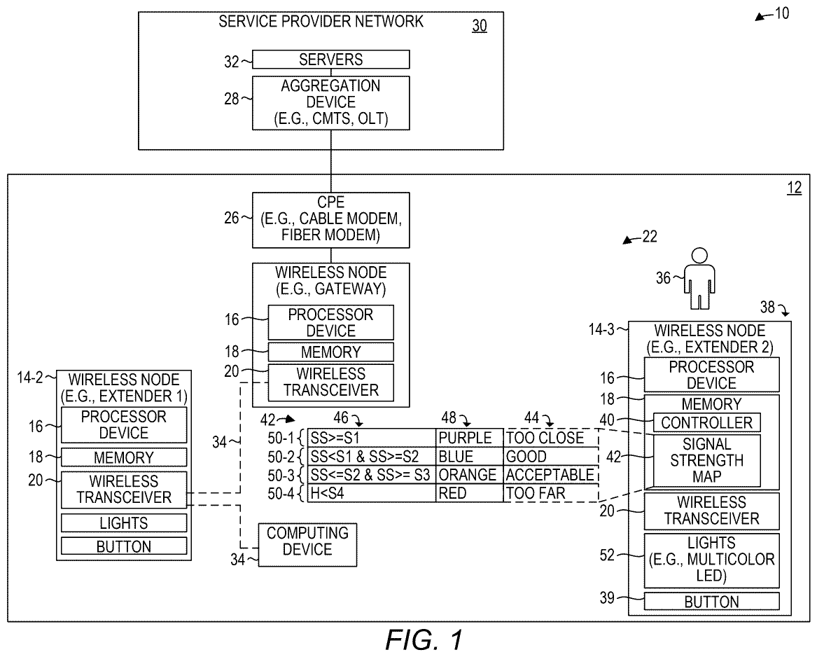

FIG. 1 is a block diagram of an environment 10 in which rapid mesh node placement cues can be practiced according to some implementations. A premises 12 includes a wireless node 14-1, a wireless node 14-2 and a wireless node 14-3 (generally, wireless nodes 14). The wireless nodes 14 each include a processor device 16, a memory 18 and a wireless transceiver 20. The wireless nodes 14 can communicate with each other via a wireless protocol implemented via the wireless transceivers 20. For example, the wireless protocol may comprise a wireless local area network (WLAN) protocol compliant with IEEE 802.11, sometimes referred to as Wi-Fi, such as Wi-Fi 4, Wi-Fi 5, Wi-Fi 6, Wi-Fi 6E, or later generations of Wi-Fi.

In this example the wireless node 14-1 comprises a wireless gateway node that provides gateway functionality in a local area network 22. For example, the wireless node 14-1 may provide layer 3 routing functionality and firewall functionality for one or more computing devices 24 that are wirelessly connected to the wireless node 14-2 or to the wireless node 14-1. The wireless node 14-2 comprises a wireless extender node that extends the wireless range of the LAN 22 farther than the wireless range of the wireless node 14-1. The LAN 22 may comprise, for example, a wireless mesh network. In this example, the wireless node 14-1 is coupled to a CPE device 26, such as a cable modem, or a fiber modem. The CPE device 26 is communicatively coupled with an aggregation device 28 in a service provider network 30. The aggregation device 28 may comprise, for example, a cable modem termination system (CMTS) or an optical line terminal (OLT). The aggregation device 28 is coupled to upstream servers 32 that ultimately facilitate communication between the computing device 24 and the Internet or other remote servers.

In some implementations the wireless node 14-1 may comprise a bridged gateway that transparently bridges traffic between the LAN 22 and a virtual CPE (vCPE) device (not illustrated) in the service provider network 30 which provides gateway functionality such as layer 3 routing functionality, firewall functionality, or the like.

The wireless node 14-2 has established a wireless link 34 with the wireless node 14-1 which may be referred to as a backhaul link because traffic from the computing device 24 is communicated to the wireless node 14-1 via the wireless link 34. The wireless node 14-2 may have no wired communication link.

With this background an example of rapid mesh node placement cues will be discussed. A user 36, such as an owner of the premises 12 or a service technician of the service provider, intends to extend the wireless coverage of the LAN 22 by installing the wireless node 14-3 in the premises 12. Preferably the wireless node 14-3 will be placed as far from the wireless node 14-1 as possible while still maintaining a relatively strong connection between the wireless node 14-3 and the wireless node 14-1 to maximize the wireless coverage area. While this example relates to a connection between the wireless node 14-3 and the wireless node 14-1, the same process could be used to extend the wireless coverage in a direction that would involve the wireless node 14-3 connecting to the wireless node 14-2. Thus, the examples disclosed herein are not limited to connecting to a wireless gateway node and include connecting to any wireless node that is operable to transmit RF signals, such as RF beacon signals and/or RF probe response signals.

The user 36 selects a location 38 and plugs the wireless node 14-3 into the outlet. The wireless node 14-3 begins to boot. The user 36 manipulates the wireless node 14-3 to cause the wireless node 14-3 to initiate a location mode. The manipulation may comprise any suitable mechanical or electronic input. For example, the wireless node 14-3 may have a button 39 that, when pressed in a certain manner, causes the wireless node 14-3 to initiate the location mode.

The wireless node 14-1 repeatedly broadcasts an RF beacon signal advertising the service set identifier (SSID) of the LAN 22. The wireless node 14-1 may broadcast the RF beacon signal at any suitable interval, such as, by way of non-limiting example, every 100 milliseconds (MS). The RF beacon signal may include, for example, the SSID (e.g., network name), broadcast capabilities of the network such as supported data rates and encryption types, and the BSSID (MAC address of the AP). The wireless node 14-3 may receive the RF beacon signals. The wireless node 14-3 may also send RF probe request signals. Such RF probe request signals may be include an SSID that the wireless node 14-3 is aware of because the SSID has already been configured in the wireless node 14-3, or the RF probe request signals may be broadcast RF probe requests that do not include an SSID but that ask any nearby wireless gateways/access points to announce themselves. The wireless node 14-1, in response to receiving a RF probe request signal, generates and sends an RF probe response signal.

The wireless node 14-3 receives an RF signal set comprising one or more RF beacon signals and/or RF probe responses from the wireless node 14-1. Note that the wireless node 14-3 may not yet even have attempted to authenticate or otherwise establish a communication link with the wireless 14-1. A controller 40 determines a signal strength based on the one or more RF signals in the RF signal set. The signal strength may be quantified, by way of non-limiting example, as a Received Signal Strength Indicator (RSSI), typically measured in decibels relative to a milliwatt (dBm). Where there is more than one RF signal in the RF signal set, the controller 40 may use any suitable algorithm to determine the signal strength, such as an averaging algorithm or the like.

The controller 40 accesses a data structure, in this example a signal strength map 42, that correlates signal strengths to corresponding location categories and corresponding perceptible events. In this example, four location categories exist, as indicated by an explanatory column 44. The four location categories are a too close location category, a good location category, an acceptable location category, and a too far location category. In other implementations there may be fewer than four location categories or more than four location categories. A column 46 identifies signal strengths (SS) and signal strength thresholds (S1, S2, S3 and S4). A column 48 identifies perceptible events, in this example blinking light colors, that the wireless node 14-3 may emit.

For example, assume that S1=−30, S2=−67, S3=−70 and S4=−80. If, for example, the signal strength (SS) is −20, the controller determines that the signal strength meets the condition SS>=S1 identified in a row 50-1 of the signal strength map 42, and causes a multicolored light 52 to emit a blinking purple color to indicate the too close location category to the user 36. If, for example, the signal strength is-40, the controller determines that the signal strength meets the condition SS<S1 & SS>=S2 identified in a row 50-2 of the signal strength map 42, and causes the multicolored light 52 to emit a blinking blue color to indicate the good location category to the user 36.

If, for example, the signal strength is −68, the controller determines that the signal strength meets the condition SS<=S2& SS>=S3 identified in a row 50-3 of the signal strength map 42, and causes the multicolored light 52 to emit a blinking orange color to indicate the acceptable location category to the user 36. If, for example, the signal strength is −81, the controller determines that the signal strength meets the condition SS<S4 identified in a row 50-4 of the signal strength map 42, and causes the multicolored light 52 to emit a blinking red color to indicate the too far location category to the user 36.

It is noted that, because the controller 40 is a component of the wireless node 14-3, functionality implemented by the controller 40 may be attributed to the wireless node 14-3 generally. Moreover, in examples where the controller 40 comprises software instructions that program the processor device 16 to carry out functionality discussed herein, functionality implemented by the controller 40 may be attributed herein to the processor device 16.

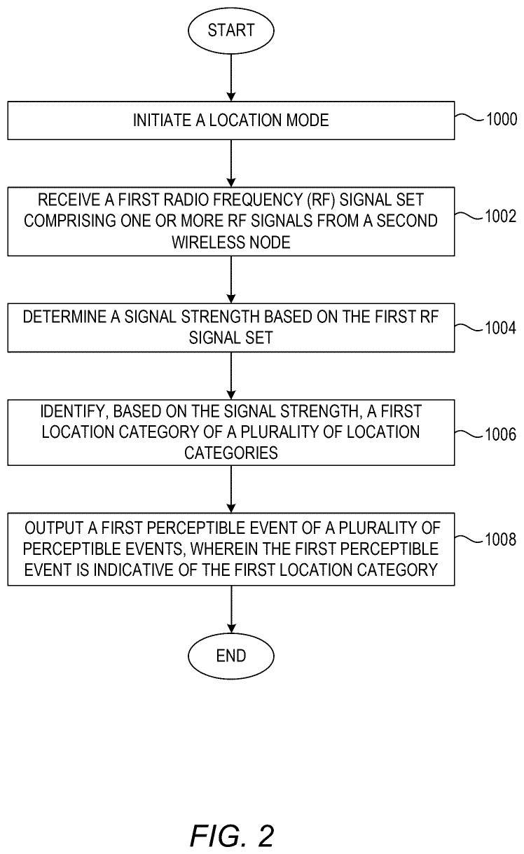

FIG. 2 is a flowchart of a method for implementing rapid mesh node placement cues according to some implementations. FIG. 2 will be discussed in conjunction with FIG. 1. The wireless node 14-3 (e.g., a first wireless node) initiates the location mode (FIG. 2, block 1000). The wireless node 14-3 receives a first RF signal set comprising one or more RF signals from the wireless node 14-1 (e.g., a second wireless node) (FIG. 2, block 1002). The wireless node 14-3 determines a signal strength based on the first RF signal set (FIG. 2, block 1004). The wireless node 14-3 identifies, based on the signal strength, a first location category of a plurality of location categories (FIG. 2, block 1006). The wireless node 14-3 outputs a first perceptible event of a plurality of perceptible events, wherein the first perceptible event is indicative of the first location category (FIG. 2, block 1008).

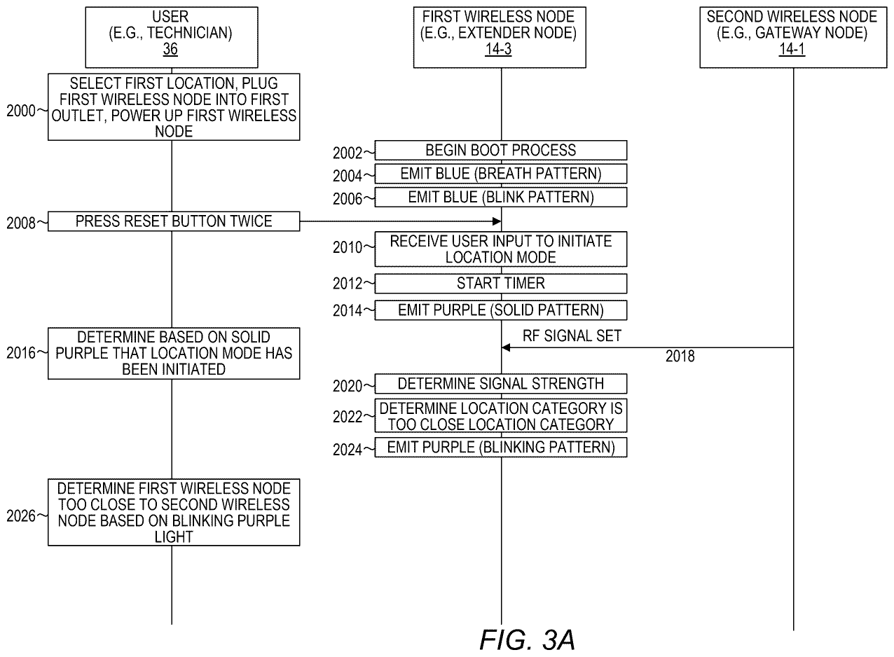

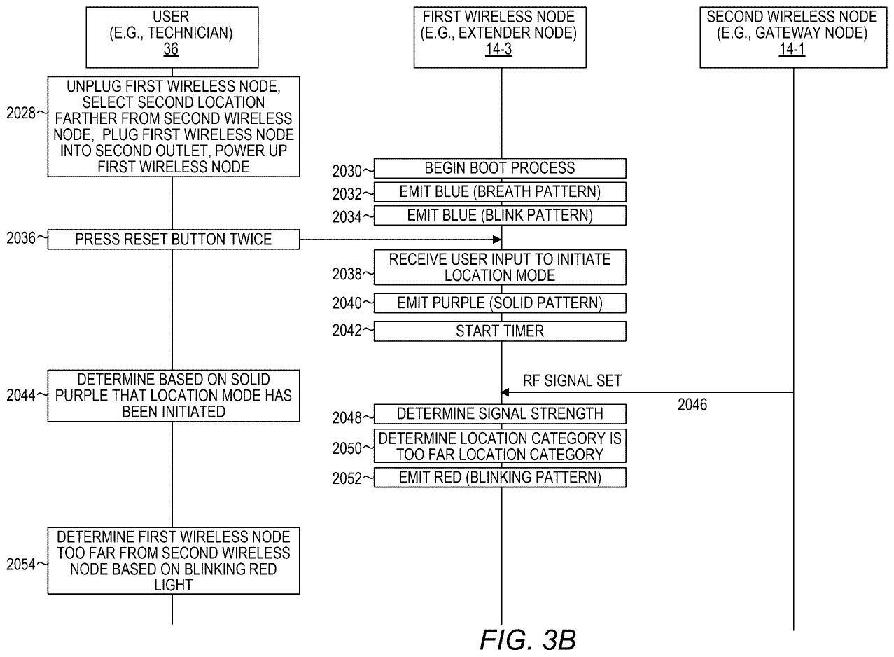

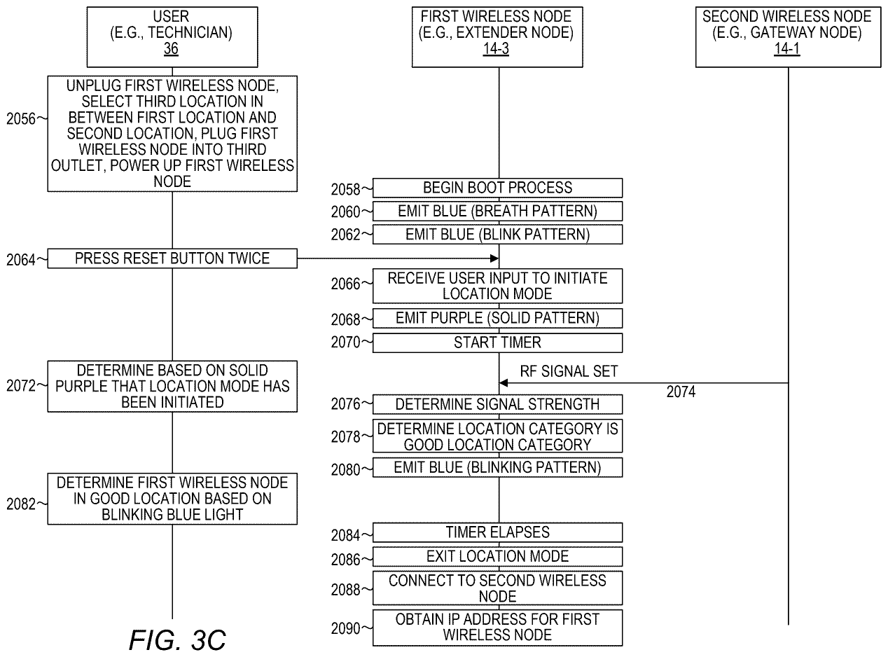

FIGS. 3A-3C illustrate a sequence diagram illustrating an example implementation of rapid mesh node placement cues according to one implementation. Referring first to FIG. 3A, the user 36 selects a first location some distance from the wireless node 14-1 and plugs the wireless node 14-3 into an electrical outlet. The wireless node 14-3 begins to power up (FIG. 3A, step 2000). The wireless node 14-3 begins a boot process that involves an operating system initiating and initiating processes that are necessary for the functioning of the wireless node 14-3 (FIG. 3A, step 2002). The wireless node 14-3 may cause the lights 52 to emit a blue color in a breathing pattern, such that the blue color fades in and out slowly (FIG. 3A, step 2004). Once the wireless node 14-3 finishes the boot sequence, the wireless node 14-3 may cause the lights 52 to emit a blue color in a blinking pattern (FIG. 3A, step 2006). The blue light blinking pattern is a cue (e.g., a perceptible event) to the user 36 that the wireless node 14-3 can be placed into the location mode if desired.

The user 36 provides user input requesting the wireless node 14-3 to initiate the location mode (FIG. 3A, step 2008). In this example, the button 39 is a reset button and pressing the reset button twice in relatively rapid succession is an indication to the wireless node 14-3 to initiate the location mode. The wireless node 14-3 receives the user input to initiate the location mode (FIG. 3A, step 2010).

The wireless node 14-3 initiates the location mode. In particular, after receiving the user input to initiate the location mode the wireless node 14-3 substantially concurrently, such as within 500 ms, starts a timer and outputs a perceptible signal indicative of the location mode by, for example, causing the lights 52 to emit a solid (e.g., non-blinking) purple light (FIG. 3A, steps 2012, 2014). The user 36 determines, based on the solid purple light, that the wireless node 14-3 has initiated the location mode (FIG. 3A, step 2016). The wireless node 14-3 receives an RF signal set comprising one or more RF signals from the wireless node 14-1 (FIG. 3A, step 2018). The RF signal set may include a single RF signal or multiple RF signals. The RF signal set may include one or more RF beacon signals transmitted by the wireless node 14-1. The wireless node 14-3 may also send RF probe requests, and the RF signal set may include one or more RF probe responses of the wireless node 14-1 made in response to the RF probe requests. The RF signal set may be obtained relatively rapidly, such as within one or two seconds.

The wireless node 14-3 determines a signal strength based on the RF signal set (FIG. 3A, step 2020). Where the RF signal set comprises multiple RF signals, the wireless node 14-3 may average the RF signals to determine the signal strength. The wireless node 14-3 accesses the signal strength map 42 to identify the location category. In this example, assume that the wireless node 14-3 identifies the too close location category based on the signal strength (FIG. 3A, step 2022). Based on row 50-1 of the signal strength map 42, the wireless node 14-3 emits a purple blinking pattern (FIG. 3A, step 2024). The user 36 determines that the wireless node 14-3 is too close to the wireless node 14-1 based on the purple blinking pattern (FIG. 3A, step 2026).

It is noted that the sequence of steps 2000-2026 may occur even before the wireless node 14-3 has authenticated with the wireless node 14-1, and before the wireless node 14-3 has established a connection with the wireless node 14-1 such as by sending an association request to the wireless node 14-1.

Referring now to FIG. 3B, the user 36 selects a second location farther from the wireless node 14-1 and plugs the wireless node 14-3 into an electrical outlet. The wireless node 14-3 begins to power up (FIG. 3A, step 2028). Steps 2030-2044 are identical to steps 2002-2016 discussed above with regard to FIG. 3A and for the sake of brevity will not be repeated. At step 2046 the wireless node 14-3 receives an RF signal set comprising one or more RF signals from the wireless node 14-1 (FIG. 3B, step 2046). The RF signal set may include a single RF signal or multiple RF signals. Again, the RF signal set may include one or more RF beacon signals transmitted by the wireless node 14-1 and/or one or more RF probe responses of the wireless node 14-1 made in response to RF probe requests from the wireless node 14-3.

The wireless node 14-3 determines a signal strength based on the RF signal set (FIG. 3B, step 2048). The wireless node 14-3 accesses the signal strength map 42 to identify the location category. In this example, assume that the wireless node 14-3 identifies the too far location category based on the signal strength (FIG. 3B, step 2050). The wireless node 14-3 outputs a perceptible event indicative of the too far location category (FIG. 3B, step 2052). In this example, based on row 50-4 of the signal strength map 42, the wireless node 14-3 emits a red blinking pattern. The user 36 determines that the wireless node 14-3 is too far from the wireless node 14-1 based on the red blinking pattern (FIG. 3B, step 2054).

Referring now to FIG. 3C, the user 36 selects a third location in between the first location and the second location from the wireless node 14-1 and plugs the wireless node 14-3 into an electrical outlet. The wireless node 14-1 begins to power up (FIG. 3C, step 2056). Steps 2058-2072 are identical to steps 2002-2016 discussed above with regard to FIG. 3A and for the sake of brevity will not be repeated. At step 2074 the wireless node 14-3 receives an RF signal set comprising one or more RF signals from the wireless node 14-1 (FIG. 3B, step 2074). The RF signal set may include a single RF signal or multiple RF signals. Again, the RF signal set may include one or more RF beacon signals transmitted by the wireless node 14-1 and/or one or more RF probe responses of the wireless node 14-1 made in response to RF probe requests from the wireless node 14-3.

The wireless node 14-3 determines a signal strength based on the RF signal set (FIG. 3C, step 2076). The wireless node 14-3 accesses the signal strength map 42 to identify the location category. In this example, assume that the wireless node 14-3 identifies the good location category based on the signal strength (FIG. 3C, step 2078). The wireless node 14-3 outputs a perceptible event indicative of the good location category (FIG. 3C, step 2080). In this example, based on row 50-2 of the signal strength map 42, the wireless node 14-3 emits a blue blinking pattern. The user 36 determines that the wireless node 14-3 is in a good location with respect to the wireless node 14-1 based on the blue blinking pattern (FIG. 3C, step 2082).

The timer that was set in step 2070 elapses (FIG. 3C, step 2084). In this implementation the elapsing of the timer indicates that the location mode is to be exited. The wireless node 14-3 exits the location mode and turns off the visible signal indicative of the location mode, in this example the purple light (FIG. 3C, step 2086). The wireless node 14-3 connects to the wireless node 14-1 (FIG. 3C, step 2088). For example, the wireless node 14-3 may send authentication credentials to the wireless node 14-1. Once accepted by the wireless node 14-1, the wireless node 14-3 sends an association request signal to the wireless node 14-1 and the wireless node 14-1 responds with an association response signal. The wireless node 14-3 obtains an IP address via the wireless node 14-1 for use with the wireless node 14-3 (FIG. 3C, step 2090). The wireless node 14-3 may now initiate a broadcast of the SSID associated with the LAN 22 and subsequently allow computing devices to connect to the wireless node 14-3. Note that while in this example the wireless node 14-3 connected with the wireless node 14-1 subsequent to exiting the location mode, in other implementations the wireless node 14-3 may, in parallel with the processing performed while in the location mode, connect to the wireless node 14-1.

It is noted that, while the perceptible events described herein have related to lights of various colors and patterns, the examples are not limited to any particular perceptible events. Any suitable perceptible events perceivable by a human may be used, including, for example, audio messages, audible sounds, or the use of a display device on the wireless node 14-3 capable of presenting text and/or suitable graphics.

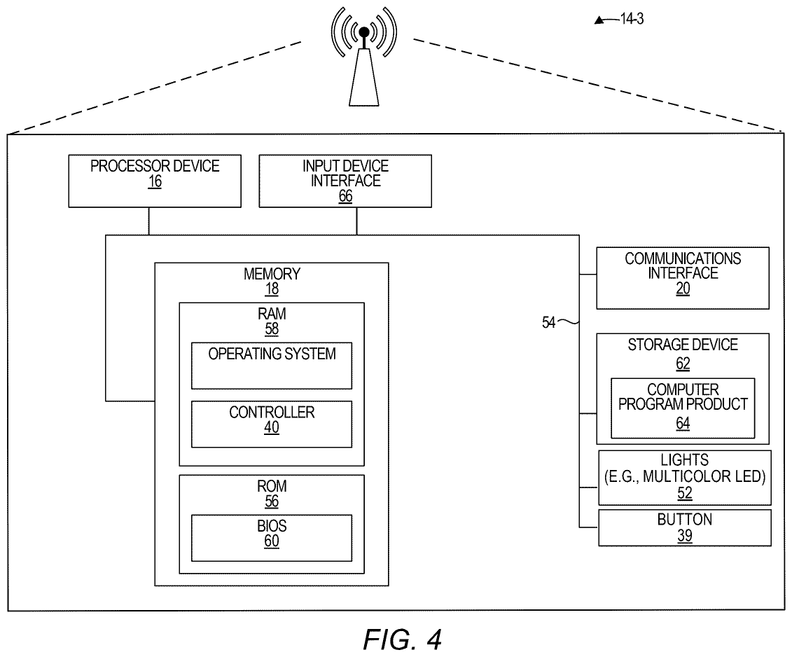

FIG. 4 is a block diagram of the wireless node 14-3 suitable for implementing examples according to one example. The wireless node 14-3 may comprise any wireless access point, gateway, mesh node, or the like, capable of communicating with another wireless node as described herein. The wireless node 14-3 includes the processor device 16, the system memory 18, and a system bus 54. The system bus 54 provides an interface for system components including, but not limited to, the system memory 18 and the processor device 16. The processor device 16 can be any commercially available or proprietary processor.

The system bus 54 may be any of several types of bus structures that may further interconnect to a memory bus (with or without a memory controller), a peripheral bus, and/or a local bus using any of a variety of commercially available bus architectures. The system memory 18 may include non-volatile memory 56 (e.g., read-only memory (ROM), erasable programmable read-only memory (EPROM), electrically erasable programmable read-only memory (EEPROM), etc.), and volatile memory 58 (e.g., random-access memory (RAM)). A basic input/output system (BIOS) 60 may be stored in the non-volatile memory 56 and can include the basic routines that help to transfer information between elements within the wireless node 14-3. The volatile memory 58 may also include a high-speed RAM, such as static RAM, for caching data.

The wireless node 14-3 may further include or be coupled to a non-transitory computer-readable storage medium such as a storage device 62, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 62 and other drives associated with computer-readable media and computer-usable media may provide non-volatile storage of data, data structures, computer-executable instructions, and the like.

A number of modules can be stored in the storage device 62 and in the volatile memory 58, including an operating system and one or more program modules, such as the controller 40, which may implement the functionality described herein in whole or in part. All or a portion of the examples may be implemented as a computer program product 64 stored on a transitory or non-transitory computer-usable or computer-readable storage medium, such as the storage device 62, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the controller 40 in the volatile memory 58, may serve as a controller, or control system, for the wireless node 14-3 that is to implement the functionality described herein.

An operator, such as the user 36, may also be able to enter one or more configuration commands through an input device, such as, for example, the button 39 or other suitable input mechanisms. Such input devices may be connected to the processor device 16 through an input device interface 66 that is coupled to the system bus 54 but can be connected by other interfaces such as a parallel port, an Institute of Electrical and Electronic Engineers (IEEE) 1394 serial port, a Universal Serial Bus (USB) port, an IR interface, and the like. The wireless node 14-3 may also include the wireless transceiver 20, such as a Wi-Fi transceiver, or the like, suitable for communicating with the wireless nodes 14-1 or 14-2 as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
initiating, by a first wireless node, a location mode;
receiving, by the first wireless node, a first radio frequency (RF) signal set comprising one or more RF signals from a second wireless node;
determining, by the first wireless node, a first signal strength based on the first RF signal set;
identifying, by the first wireless node based on the first signal strength, a first location category of a plurality of location categories; and
outputting a first perceptible event of a plurality of perceptible events, wherein the first perceptible event is indicative of the first location category.

2. The method of claim 1, further comprising:
substantially concurrently with initiating the location mode:
outputting, by the first wireless node, a perceptible signal indicative of the location mode; and
starting a timer.

3. The method of claim 2, further comprising:
in response to determining that the timer has elapsed:
exiting the location mode; and
turning off the perceptible signal indicative of the location mode.

4. The method of claim 1, wherein the second wireless node comprises a wireless gateway node or a wireless extender node.

5. The method of claim 1, further comprising:
sending, by the first wireless node to the second wireless node, authentication credentials; and
connecting, by the first wireless node, to the second wireless node.

6. The method of claim 5, wherein connecting to the second wireless node occurs subsequent to outputting the first perceptible event.

7. The method of claim 1, further comprising:
prior to initiating the location mode, receiving, by the first wireless node, a user input requesting the first wireless node to initiate the location mode.

8. The method of claim 1, wherein the first RF signal set comprises a beacon signal identifying a service set identifier (SSID) of the second wireless node.

9. The method of claim 1, further comprising:
sending, by the first wireless node, a probe request signal, and wherein the first RF signal set comprises a probe response signal made in response to the probe request signal.

10. The method of claim 1, wherein the first location category comprises a too close location category, a too far location category, or a good location category.

11. The method of claim 1, wherein the first location category comprises a too close location category or a too far location category, and further comprising:
initiating, by the first wireless node, the location mode;
receiving, by the first wireless node, a second RF signal set comprising one or more RF signals from the second wireless node;
determining, by the first wireless node, a second signal strength based on the second RF signal set;
identifying, by the first wireless node based on the second signal strength, a second location category of the plurality of location categories, the second location category differing from the first location category; and
outputting a second perceptible event of the plurality of perceptible events, wherein the second perceptible event is indicative of the second location category.

12. The method of claim 1, wherein the first RF signal set comprises a single RF signal.

13. The method of claim 1, wherein the first RF signal set comprises a plurality of RF signals, and wherein determining the first signal strength based on the first RF signal set comprises determining an average signal strength of the plurality of RF signals.

14. The method of claim 1, wherein the first perceptible event comprises a first colored light of a plurality of different colored lights.

15. The method of claim 1, further comprising:
subsequent to outputting the first perceptible event, requesting, by the first wireless node via the second wireless node, an Internet Protocol (IP) address for use by the first wireless node.

16. The method of claim 1, further comprising:
subsequent to outputting the first perceptible event, initiating, by the first wireless node, a broadcast of a service set identifier (SSID) associated with the first wireless node.

17. A first wireless node, comprising:
a memory; and
a processor device communicatively coupled to the memory and operable to:
initiate a location mode;
receive a first radio frequency (RF) signal set comprising one or more RF signals from a second wireless node;
determine a first signal strength based on the first RF signal set;
identify, based on the first signal strength, a first location category of a plurality of location categories; and
output a first perceptible event of a plurality of perceptible events, wherein the first perceptible event is indicative of the first location category.

18. The first wireless node of claim 17, wherein the first location category comprises a too close location category or a too far location category, and wherein the processor device is further operable to:
initiate the location mode;
receive a second RF signal set comprising one or more RF signals from the second wireless node;
determine a second signal strength based on the second RF signal set;
identify, based on the second signal strength, a second location category of the plurality of location categories, the second location category differing from the first location category; and
output a second perceptible event of the plurality of perceptible events, wherein the second perceptible event is indicative of the second location category.

19. The first wireless node of claim 17, wherein the processor device is further operable to:
prior to initiating the location mode, receive a user input requesting the first wireless node to initiate the location mode.

20. A non-transitory computer-readable storage medium that includes executable instructions operable to cause a processor device of a first wireless node to:
initiate a location mode;
receive a first radio frequency (RF) signal set comprising one or more RF signals from a second wireless node;
determine a signal strength based on the first RF signal set;
identify, based on the signal strength, a first location category of a plurality of location categories; and
output a first perceptible event of a plurality of perceptible events, wherein the first perceptible event is indicative of the first location category.
